(19) United States
(12) Patent Application Publication
(10) Pub. No.: US 2019/0242024 A1
(43) Pub. Date: Aug. 8, 2019

(54) SELECTIVE ELECTROPLATING OF 3D PRINTED PARTS

(71) Applicant: U.S. Army Research Laboratory ATTN: RDRL-LOC-I, Adelphi, MD (US)

(72) Inventors: Nathan S. Lazarus, Bethesda, MD (US); Kristin E. Angel, Troy, NJ (US)

(21) Appl. No.: 16/209,147

(22) Filed: Dec. 4, 2018

Related U.S. Application Data
(60) Provisional application No. 62/626,266, filed on Feb. 5, 2018.

(51) Int. Cl. C25D 5/12; C25D 7/12; C25D 3/12; B29C 64/336; B29C 64/118; B29C 64/112; B29C 64/295

(52) U.S. Cl. CPC C25D 5/12; C25D 7/123; C25D 3/12; B29C 64/295; B29C 64/118; B29C 64/112; B29C 64/336

(57) ABSTRACT

Systems, methods, architectures, mechanisms and/or apparatus configured to provide selective electroplating of a fused deposition modeling (FDM) printed article without the use of additional intermediate steps.

### CROSS-REFERENCE TO RELATED APPLICATION

This application claims the benefit of and priority to prior filed co-pending Provisional Application Ser. No. 62/626,266, filed Feb. 5, 2018, entitled SELECTIVE ELECTROPLATING OF 3D PRINTED PARTS (Attorney Docket No. ARL-17-44P), which provisional patent application is incorporated herein by reference in its entirety.

### GOVERNMENT INTEREST

The embodiments described herein may be manufactured, used and/or licensed by or for the United States Government without the payment of royalties thereon.

### FIELD OF THE DISCLOSURE

The embodiments herein generally relate to 3D printing and, more particularly, to multiple material additive manufacturing for generating 3D components having portions thereof configured for immediate electroplating.

### BACKGROUND

Three-dimensional (3D) printing is becoming more popular, but common printing techniques typically have a limited selection of printable materials, and thus a correspondingly limited range of products that can be printed. Traditionally, 3D printing has been limited to non-conductive materials, such as thermoplastics. While some materials having slight or limited conductivity can be printed, these materials are simply not as conductive as materials such as copper and, therefore, the range of products that can be printed is still relatively limited.

Prior art approaches to this problem include either separately electroplating an entire 3D printed component, or using an intermediate step such as painting the 3D printed component with a conductive coating (e.g., silver paint) to selectively electroplate a portion of the 3D printed component. These and other approaches are unsatisfactory.

### SUMMARY

Various deficiencies in the prior art are addressed by systems, methods, architectures, mechanisms and/or apparatus configured to provide selective electroplating of a fused deposition modeling (FDM) printed article without the use of additional intermediate steps.

A method of fabricating a component according to one embodiment comprises using a dual material additive manufacturing process configured to selectively deposit onto a substrate a relatively non-conductive polymer material and a relatively conductive polymer material to form thereby a three dimensional (3D) structure having respective non-conductive sections and conductive sections, the conductive polymer material including conductive composite filaments; and using an electroplating process configured to deposit a metallic layer onto at least one of the conductive sections of the 3D structure to form the component.

### BRIEF DESCRIPTION OF THE DRAWINGS

The teachings herein can be readily understood by considering the following detailed description in conjunction with the accompanying drawings, in which:

FIG. 1 depicts a high-level block diagram of an apparatus according to an embodiment;

FIG. 2 depicts a flow diagram of a method according to an embodiment;

FIGS. 3A-3B graphically depict an exemplary test/production setup useful in understanding the present embodiments;

FIGS. 4A-4H depict examples of three dimensional structures or components formed according to the various embodiments and subjected to selective or multiple electroplating processes;

FIGS. 5A-5D depict a three dimensional tunneling structure useful in providing electrical communication with otherwise inaccessible conductive sections/portions of a three dimensional structure or component

FIGS. 6A-6B depict front and back views of printed circuit board via structures formed in accordance with the various embodiments;

FIG. 7 depict an example of a three dimensional structure formed in accordance with the various embodiments; and

FIG. 8 depicts a high-level block diagram of a computing device, such as a processor or other functional element suitable for use within the system 100 of FIG. 1.

To facilitate understanding, identical reference numerals have been used, where possible, to designate identical elements that are common to the figures.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Generally speaking, the various embodiments enable the fabrication of complicated 3D parts on demand (including electronic and magnetic components) using multiple additive manufacturing materials including at least one material suitable for immediate electroplating to thereby improve aesthetics, improve mechanical properties, increase conductivity, add a magnetic response and/or achieve other design/performance goals.

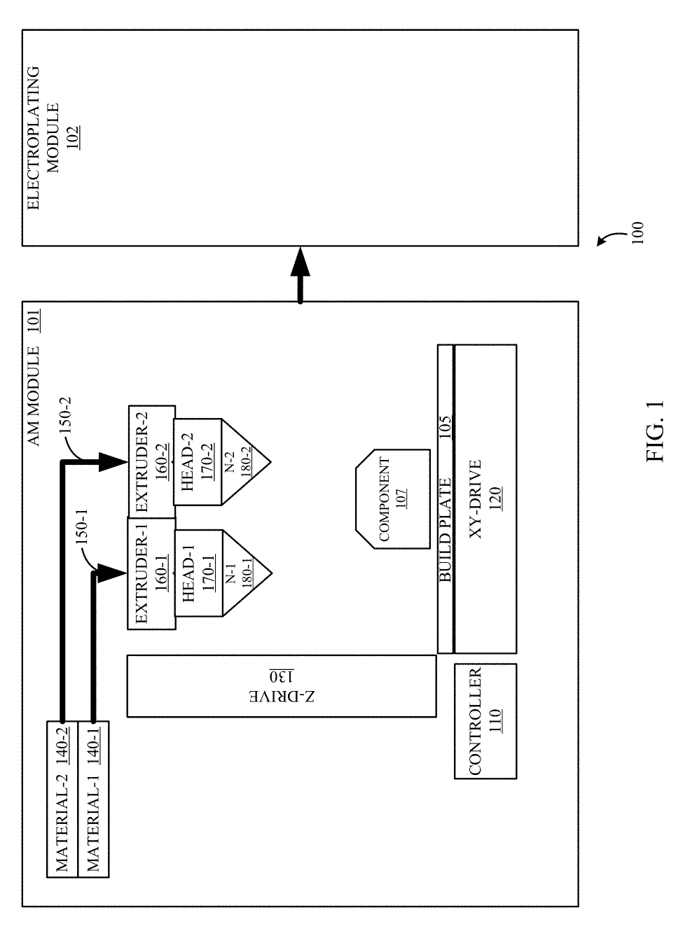

FIG. 1 depicts a high-level block diagram of an apparatus according to an embodiment herein. Specifically, FIG. 1 depicts a high-level block diagram of an apparatus 100 comprising an additive manufacturing (AM) module (3D printer) 101 and electroplating module 102.

The 3D printer 101 comprise, illustratively, a dual material 3D printer having a build plate 105 upon which a 3D component 107 is formed by an additive manufacturing process using two different materials. A first material stored in a first material storage 140-1 is delivered via a first conveyor 150-1 to a first extruder 160-1 where a first heater 170-1 heats the first material and accurately delivers heated/extruded first material via a first nozzle 180-1 to the build plate 105 or component 107 being formed thereon. Similarly, a second material stored in a second material storage 140-2 is delivered via a second conveyor 150-2 to a second extruder 160-2 where a second heater 170-2 heats the second material and accurately delivers heated/extruded second material via a second nozzle 180-2 to the build plate 105 or component 107 being formed thereon.

The 3D printer 101 includes an XY-drive 120 operative to move the build plate 105 in the X and Y directions with respect to the nozzles 180, and a Z-drive 130 operative to move the build plate 105 in the Z direction with respect to the nozzles 180.

The 3D printer 101 includes a controller 110 operative to receive component-descriptive data and control the various elements and submodules within the 3D printer 101 (many of which are omitted to simplify the discussion) to produce a component in accordance with the component data.

In various embodiments, the 3D printer 101 comprises a fused filament fabrication (FFF) or fused deposition modeling (FDM) printer, in which thermoplastic filament is extruded through a heated nozzle to print lines of melted polymer and build parts one layer at a time. In other embodiments, the 3D printer may comprise or use a stereolithography additive manufacturing (SLA), Multi Jet Modeling (MJM), Inkjet and/or other additive manufacturing or 3D printing device/technology.

Specifically, the various embodiments contemporaneously print using a nonconductive polymer, illustratively a thermoplastic material such as ABS (acrylonitrile butadiene styrene) or PLA (polylactic acid) and a conductive polymer such as a composite material (e.g., Proto-pasta CDP11705 Electrically Conductive Carbon Black filament) on a FFF/FDM 3D printer with multiple extruder heads such that electrically isolated regions can be defined, allowing selective electroplating only in predefined regions. This same technique may be used to deposit two different metals in different areas of the part. The 3D printer prints in layers, switching material during each layer; such as by printing PLA from the first nozzle 180-1 followed by conductive composite from the second nozzle 180-2 before moving up to the next layer to repeat the process. In this manner, individual parts to have multiple overlapping materials may be produces.

The conductive composite filament is used to create parts and portions thereof that can be selectively electroplated, thereby giving the low conductivity composite a higher conductivity outer layer. A single part can even be designed with multiple conductive segments that are electrically isolated, allowing for multiple materials to be electroplated on one part without overlap. Intricate designs can be made in this manner including 30 objects. Since the electroplating increases the conductivity, electrical components such as solenoid inductors can be built in this manner.

The various embodiments enable the generation of three-dimensional structures or components having conductive and nonconductive portions, sections or regions. Further, various embodiments contemplate additional materials, optionally with additional material handling and utilization paths (140-180) to form portions, sections or regions of the three dimensional structures have additional capabilities or properties.

Other (non-FFF/FDM) AM technologies may use other types of polymers, such as photo polymers and the like, which polymers are configured to provide a relatively non-conductive polymer and a relatively conductive polymer, where the relatively non-conductive polymer is configured to reject the deposition thereon of metal via electroplating, where the relatively conductive polymer is configured to accept the deposition thereon of metal via electroplating.

Electroplating module 102 comprises a relatively standard electroplating system operative to deposit metal upon conductive surfaces such as the conductive portions or sections of a 3D component or article produced by the 3D printer 101. In various embodiments, the electroplating module 102 is a stand-alone system, whereas in other embodiments the electroplating module 102 is integrated within the apparatus 100 and directly provided with components or articles produced but the 3D printer 101.

Generally speaking, the electroplating module 102 uses an applied voltage in an electrochemical cell to deposit material upon the conductive surfaces to increase conductivity, change mechanical behavior, add properties such as a magnetic response and/or modify other functional or athletic properties associated with the component or article produced by the 3D printer 101.

Electroplating module 102 processes printed parts directly or mounted in a custom 3D printed holder to establish electrical contact to the plating power supply. A copper foil is clamped against the conductive composite region of the part, with the casing designed to prevent electroplating solution from making contact with the copper foil, allowing only the conductive region to be accessible during the plating process. One method to establish good contact between the foil and the conductive segment is to use raised patterns on the back of the casing piece.

In various embodiments, the apparatus 100 is operable to effectively create electronic parts such as inductors and antennas by constructing the three dimensional shapes using nonconductive and conductive portions, sections or regions and electroplating the conductive portions, sections or regions.

Various embodiments and/or use cases may require differing materials and/or techniques. As such, the process may be adjusted as necessary depending upon characteristics such as the conductivities of the composite filament, electrodeposition rates (e.g., as a function of function of printing orientation), adhesion requirements, electroplating techniques and goals, and so on.

With respect to the resistivity of the conductive filament, it is noted that due to the layers inherent in FFF printing, the orientation of a part while printing can affect the build quality as well as the resistivity of the conductive filament.

With respect to Copper Deposition, it is noted that metal deposition during electroplating varies due to current density, time, and plating chemistry. Due to the resistivity difference from the filament orientation, a part printed flat parallel to the build plate (horizontal orientation) will have z direction resistivity between the contact and the plating solution, while a vertically oriented piece will have x/y direction resistivity.

By designing multiple conductive segments that are electrically isolated, different segments can be during electroplating at different times by, for a particular electroplating step, making contact only with the conductive portion of the part to be plated during that step (time). This same method also allows multiple materials to be electroplated onto the same 3D printed part; specifically, different metals electroplated at different steps, where at each step contact is made only with the conductive portions to which the metal at that step is intended to be electroplated.

Advantageously, selective electroplating can also be performed on the interior of 3D printed parts without it being necessary for the composite filament to have a direct line of sight with the copper anode. In particular, structures such as various length tunnels consisting of, illustratively, arches of non-conducting PLA may be formed to convey electrolytic solution to an interior conductive portion of a 3D part, where electrical contact with that portion may be made via a conductive passthrough or other structure.

For applications where having polymer in the final part is undesirable, for instance if the part is intended to be exposed to higher temperatures, the unwanted polymer may be dissolved after the electroplating process is complete using chloroform or other suitable means. This method can be used to create air bridges and different electrical components. For example, a PLA filament is completely soluble in the chloroform whereas a composite filament takes longer to dissolve and is not completely soluble, such that a residue of the conductive particulate remains after immersion in chloroform. It is noted that while chloroform is suitable for use with PLA, other solvents may be used depending upon the type of thermoplastic and/or photopolymer used in the additive manufacturing process. For example, various organic solvents such as acetone, IPA, dimethyl chloride, NMP, as well as various acids and bases may be used depending the type of polymer used and, more particularly, the type of solvent appropriate for use in dissolving that polymer.

The various embodiments find utility within the context of printed circuit board (PCB) construction. In this use case, the layering of conductive and nonconductive portions, including conductive paths in all three dimensions, underpasses, conductive paths crossing, through holes and vias, as well as many other structures are readily generated in accordance with the various embodiments described herein.

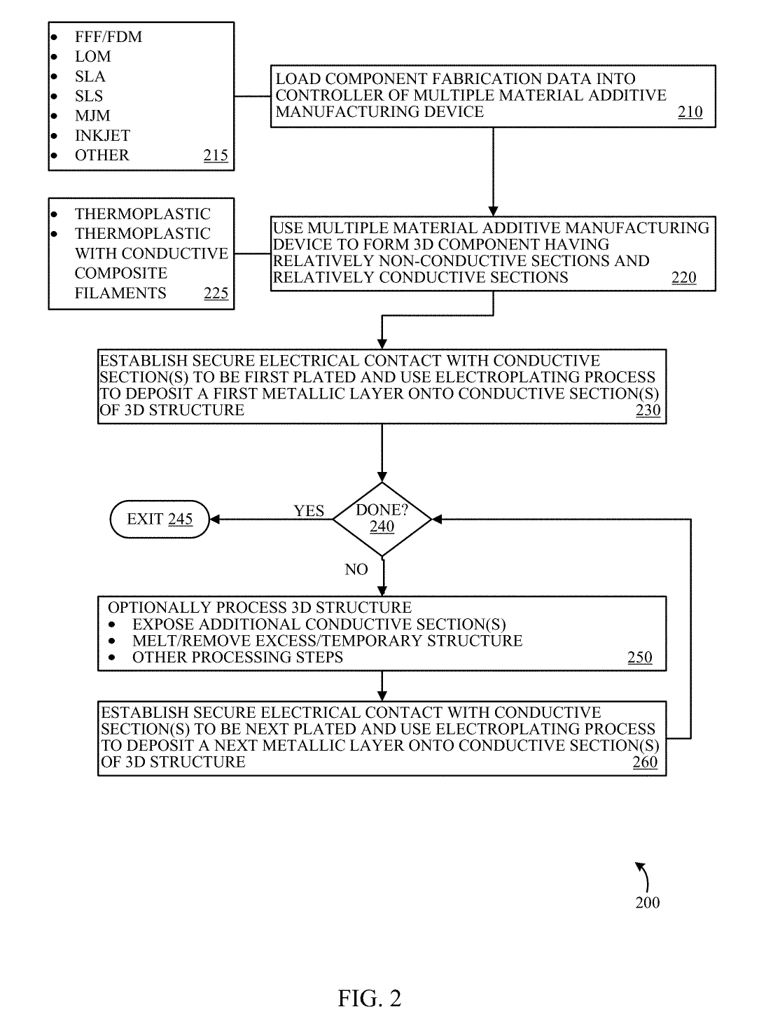

FIG. 2 depicts a flow diagram of a method according to an embodiment. Specifically, FIG. 2 depicts a method 200 of forming a three dimensional structure such as an electrical component, electromechanical component, replacement part and the like.

At step 210, component fabrication data is loaded into the controller of multiple material additive manufacturing device, such as the additive manufacturing module 101 described above with respect to FIG. 1. Referring to box 215, the additive manufacturing device may comprise any of a fused filament fabrication/fused deposition modeling (FFF/FDM), stereolithography additive manufacturing (SLA), Multi Jet Modeling (MJM), Inkjet and/or other additive devices/technologies suitable for use in the embodiments as described herein. It is noted that some of these additive devices/technologies would use photopolymers rather than the thermoplastics generally discussed herein with respect to the FFF/FDM embodiments. As such, those embodiments are to be construed as described herein within the context of photopolymers rather than thermoplastics. Various types of polymers may be modified to cross link or un-crosslink due to light exposure such that they may be used in the various embodiments, such as light crosslinked silicones, acrylics, epoxies and many other polymers as is known to those skilled in the relevant arts.

At step 220, the multiple material additive manufacturing device is used to form a 3G component or structure having relatively non-conductive sections and relatively conductive sections. Referring to box 225, the relatively non-conductive sections may be formed using a thermoplastic material, whereas the relatively conductive sections may be formed using a thermoplastic with composite fiber filaments or other conductive particles, filaments, fibers and the like such that the relatively conductive sections formed thereby are sufficiently conductive so as to enable the depositing of a metallic layer thereon via electroplating processes as further discussed herein.

At step 230, the 3D component or structure formed by the multiple material additive manufacturing device is subjected to an electroplating process without further processing. In particular, secure electrical contact with one or more conductive sections is established such that an initial metallic layer may be deposited onto the electrically contacted one or more conductive sections via initial electroplating processing of the 3D component or structure.

At step 240 a determination is made as to whether the method is finished processing the 3D component or structure, or whether further processing of the 3D component or structure is appropriate. If processing is finished, then the method 200 exits at step 245. If further processing is appropriate, then the method 200 continues to step 250.

At step 250, optional processing of the 3D component or structure is provided as needed. Such optional processing may comprise exposing one or more additional conductive sections, melting/removing excess or temporary structural elements such as interim structural elements, connectors between multiple structures being simultaneously processed and so on. The optional processing provides an opportunity to reveal/access additional conductive sections or modify the shape the 3D component or structure being formed. Other processing steps may also be employed.

At step 260, the 3D component or structure subjected to initial electroplating (step 230) and optional processing (step 240) is subjected to a further electroplating process. In particular, secure electrical contact with one or more conductive sections is established such that a subsequent metallic layer may be deposited onto the electrically contacted one or conductive sections. The method 200 and proceeds to step 240.

Method 200 of FIG. 2 provides for iterative processing of a 3D component or structure being formed wherein the same or different metallic layers may be deposited upon various conductive sections and that such deposition may be performed in accordance with a sequence at processing steps which optionally include further processing of the 3D component or structure such that complex physical and electrical geometries/properties may be formed thereby.

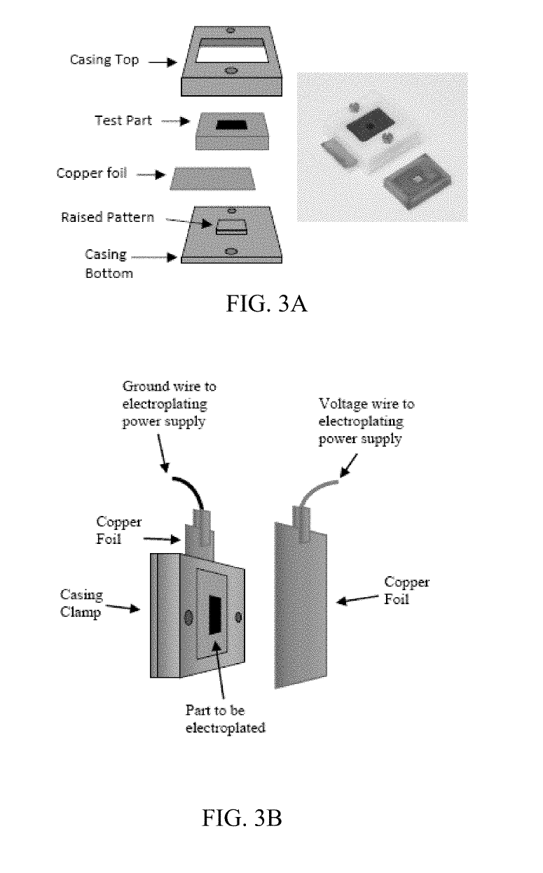

FIGS. 3A-3B graphically depict an exemplary test/production setup useful in understanding the present embodiments. In particular, the exemplary test/production setup is configured to receive from the additive manufacturing process a 3D component or structure to be subjected to electroplating, identified as a “test part” in the figures. In particular, a casing bottom having a raise patterned as disposed upon it a copper foil (or a metallic foil/conductor) upon which the test part is clamped by a casing top that the copper foil makes electrical connection with the conductive section of the test part. The copper foil contacting the conductive section of the 3D component is coupled to the ground or negative contact of the electroplating power supply, while a second copper foil (or other metallic foil/conductor) is coupled to the voltage are positive contact of the electrically power supply. Report to be electroplated and positive contacted metallic foil/conductor are immersed in an electroplating bath were a standard electroplating operation causes deposition of material from the electroplating bath onto the test part.

As a testing example, a standard copper sulfate bath was used for electroplating, the bath containing contains 100 ml of 96% by weight sulfuric acid, 100 g of copper sulfate, and 400 ml of water. A mount was 3D printed that allowed the part to hang parallel to and 25 cm away from a larger copper foil piece in the bath. Keeping the anode and 3D printed part parallel to each other results in consistent distance between the cathode and anode across the part's surface to obtain a more even copper deposition across the conductive PLA surface. The test piece was dipped into the bath to cover the section to be electroplated but the piece was kept high enough to keep the bare foil exposed above the holder out of the liquid to prevent plating on the contact electrode. A Dynatronix DuPR10-3-6 Pulse Power Supply was then used to apply current during the plating process. Following plating, the conductive region turned a uniform pink color showing consistent plating of copper.

In various embodiments, contact between the test part and copper foil is improved by using raised patterns on the top portion of the casing piece to provide increased compressive pressure between the copper foil and the portion of the test part to be plated.

Various tests were performed to measure conductivities of the composite filament and electrodeposition rates as a function of printing orientation; adhesion tests were conducted to assess the viability of this approach; selective electroplating of arbitrarily placed features was proven; and an electronic part was fabricated and tested to prove that good electrical properties are possible. Further, various embodiments contemplate multiple plating processes to deposit thereby multiple/different types of metals, multiple layers of metals and the like.

Due to the layers inherent in FFF printing, the orientation of a part while printing can affect the build quality as well as the resistivity. The various experiments, test rods with 2×2×25 mm dimensions were printed in two different directions, lengthwise (i.e., parallel to the build surface for the x/y resistivity) and perpendicular to the build surface (i.e., for the z direction resistivity). A four point resistivity measurement was then performed with a Keithley 2100 6½ Digit Multimeter on three rods for each orientation. The resistivity in the x/y direction was found to be 12.21 ohm-cm while the z direction was found to have a resistivity of 23.09 ohms-cm (with standard deviation 3.09 ohm-cm and 0.37 ohm-cm for the x/y and z orientations respectively). 3.2 Characterization of Copper Deposition Metal deposition during electroplating varies due to current density, time, and plating chemistry.

Tests pieces were designed with a consistent plating area of 20 mm2, with a plating current of 0.04 A in the copper sulfate bath, giving a current density of 0.002 A/mm2. Two sets of test pieces, one printed vertically and one horizontally, were then plated for different amounts of time to determine the plating rate. Due to the resistivity difference from the filament orientation, the part printed flat parallel to the build plate (horizontal orientation) will have the z direction resistivity between the contact and the plating solution, while the vertically oriented piece will have the x/y resistivity. The results from plating test pieces for 2, 4, 6, and 8 hours or substantially linear, with similar rates for both orientations (24 μm/hr for the vertical and 17 μm/hr for the horizontal prints), with printer resolution (roughness of final print) having a significant impact upon Rate of deposition results.

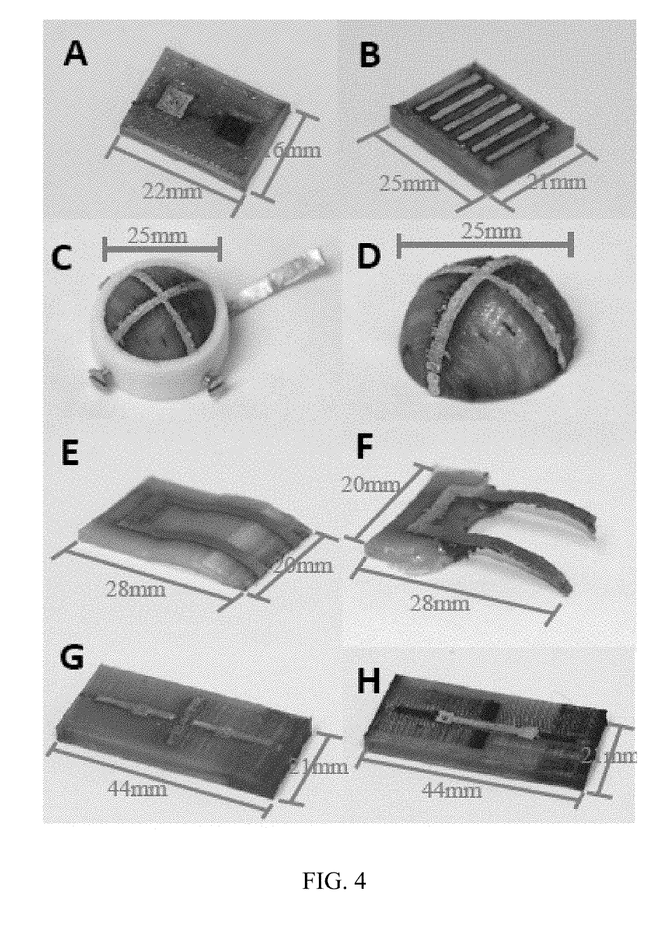

FIGS. 4A-4H depict examples of three dimensional structures or components formed according to the various embodiments and subjected to selective or multiple electroplating processes. Specifically, FIG. 4A depicts selective plating of a test piece, FIG. 4B depicts selective plating of the test piece with two metals, FIG. 4C depicts a dome in a casing for electroplating and FIG. 4E depicts a side view of the dome.

FIG. 4A depicts a rectangular test part designed with two electrically isolated conductive squares. By making electrical contact with only one conductive square, the part may be completely submerged in and electroplate bath and electroplated, with copper depositing only on the electrically contacted square. This same method also allows multiple materials to be electroplated onto the same 3D printed part. In various embodiments, three dimensional structures or components may be formed using disparate metals at different processing steps, such as by a first step using copper, a high conductivity metal, with a second step using a magnetic material (nickel), which in combination prove valuable in making devices such as a magnetic-core inductor. In one embodiment, a nickel sulfamate bath is used to plate the second metal.

FIG. 4B depicts a non-conductive PLA rectangle containing six separate conductive PLA lines with 1.5 mm width and spacing. The piece was first plated in the copper solution with electrical contact made with three of the six lines, followed by plating of the remaining three lines in the nickel plating bath, resulting in alternating copper and nickel lines with no overlap.

FIGS. 4C-4D depict three-dimensional shapes that may be defined and plated as well according to the various embodiments, illustratively dome shape with two composite lines forming an “x” wherein the dome is electroplated the same way as flat surfaces, aside from curing the copper anode to follow the arc of the dome across its surface.

In various embodiments, for applications where having polymer in the final part is undesirable, for instance if the part is intended to be exposed to higher temperatures, past work on electroplating of 3D printed parts has demonstrated dissolving the plastic to leave only the plated metal. For the selective plating process demonstrated here, a similar process is possible using chloroform to dissolve the PLA to leave behind plated copper.

Specifically, FIG. 4F a thermoplastic component having a metallized layered disposed and portions thereof, FIG. 4G depicts the thermoplastic component after being placed in chloroform wherein portions of the thermoplastic have been melted away, FIG. 4G depicts a top view of a that circuit board (PCB) via, and FIG. 48 depicts a bottom view of the PCB via.

The test part of FIG. 4E was dipped half in the chloroform to yield the test part of FIG. 4F, in which the PLA and composite filament dissolved where exposed to chloroform, leaving only the plated copper layer. This method can be used to create air bridges and different electrical components. The PLA filament was completely soluble in the chloroform while the composite filament took longer to dissolve and wasn't completely soluble, leaving behind a residue of the conductive particulate. With further development/improved solvent selection, the carbon black could likely also be dissolved to obtain cleaner electroplated copper parts.

Various embodiments, a variation on the above technique is use for the creation of a 3D printed circuit board. Printed circuit boards (PCBs) are an important and widely used technology in electronics manufacturing, with a market size of tens of billions of dollars every year. In a PCB, layers of metal used for electrical interconnect are patterned on insulating layers used for mechanical support and isolation to create a laminated board. While it is possible to make a single layer PCB, multi-layer and double-sided boards allow far more complexity but also require the capability for connection between layers to allow crossover of electrical traces. The thicknesses plated in the work here roughly correspond to between 2 oz. and 4 oz. printed circuit boards according to the convention in the industry (referring to ounces of copper per square foot of board, with 1 oz. of copper equaling approximately 35 μm thick copper layers).

Various embodiments provide vertical vias and underpasses such as useful within the context of the printed circuit board. A via structure consisting of a hole surrounded by conductive PLA may be uniformly plated to join selectively plated copper traces on the front and back (FIGS. 6A-6B). This technique may be used to create an underpass, allowing two plated copper lines to cross using two plated vias (FIGS. 4G-4H). The part in FIGS. 4G-4H was plated in three steps; namely, first plating of the straight line (vertical in the image), followed by plating of the top of the horizontal line (FIG. 4G), and then finally plating of the underpass (FIG. 4H). The composite filament lines are separated from each other with PLA plastic 1 mm thick.

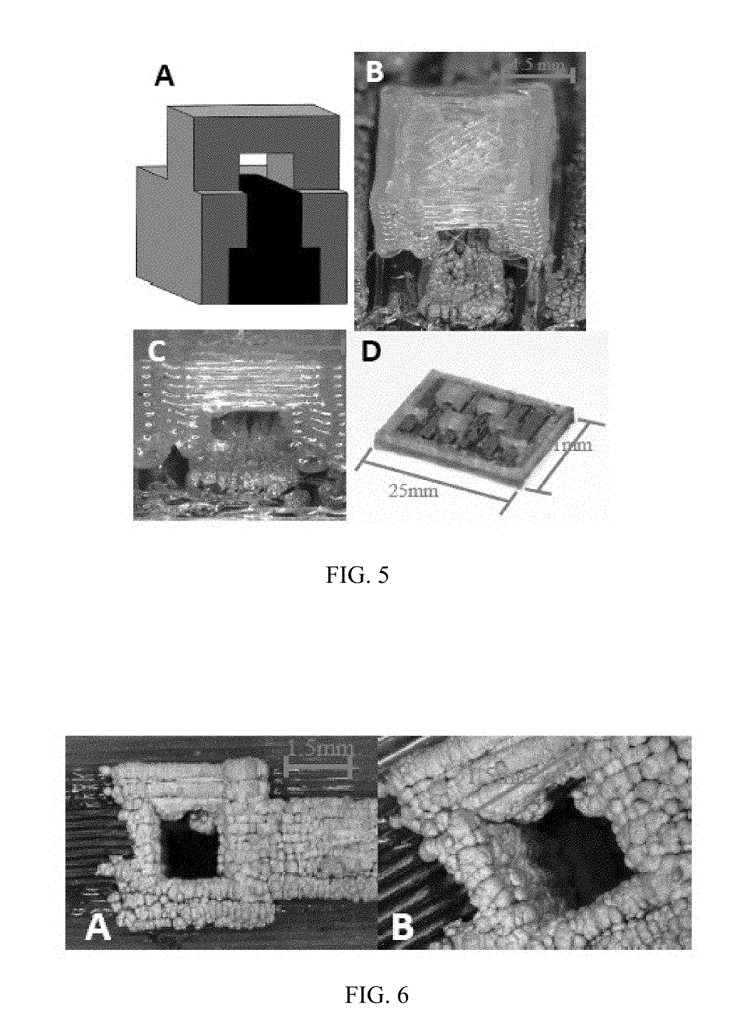

FIGS. 5A-5D depict a three dimensional tunneling structure useful in providing electrical communication with otherwise inaccessible conductive sections/portions of a three dimensional structure or component. Specifically, FIG. 5A depicts a three dimensional diagram of tunnel pre-plating, FIG. 5B depicts a 3 mm long tunnel cross-section, FIG. 5C depicts copper under the tunnel, and FIG. 5D depicts a final tunnel test component.

Specifically, the various embodiments selective electroplating is performed on the interior of three dimensional structures or components without it being necessary for the composite filament to have a direct line of sight with the copper anode. For example, various length tunnels consisting of arches of non-conducting PLA, each creating a tunnel with a 1 mm by 1.5 mm cross section, were designed above conductive lines (FIG. 5A) such that non-line-of-sight structures or conductive section formed inside (i.e., not on the surface) of the 3D structure or component may be accessed for electroplating and other purposes. The part may then be plated using the plating setup, again with an anode foil placed 25 cm from the 3D printed part. Even though there is no longer a direct path to the conductive PLA region, copper is plated successfully under the full length of every tunnel on the component, as verified by a resistance measurement along the length of the tunnel with maximum resistance of 0.3 Q showing successful plating, with maximum demonstrated tunnel length 9 mm (FIG. 5B).

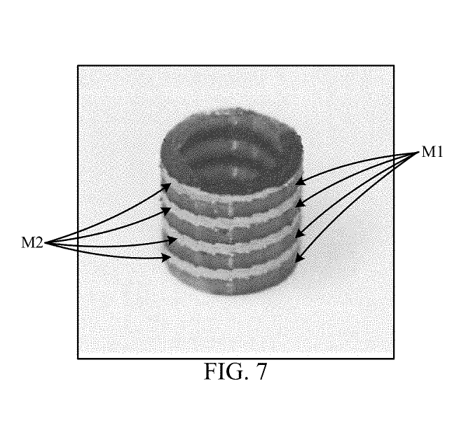

FIG. 7 depicts a three dimensional structure formed in accordance with the various embodiments, having been subjected to multiple electroplating processes. In particular, FIG. 7 depicts an air core inductor having an outer diameter of 21 mm was designed and created in accordance with the various embodiments. When plating the solenoid inductor, a motor was used to rotate the solenoid to produce an even coating around the whole piece. To avoid twisting of the wires, the motor was oscillated back and forth with an AC input from a function generator. Once a solenoid was successfully plated, an Aglilent 4294A Precision Impedance Analyzer was used to find the inductance and the resistance, averaging 191 nH and 18.7 mΩ respectively from 10 kHz to 100 kHz, a five order of magnitude reduction in resistance over the original resistance of 3 kΩ for the unplated inductor. By assuming a thickness of 150 μm and a bulk resistivity of copper to be 17.2 nΩ m, the expected resistance is calculated to be 11.3 mΩ, which is reasonably similar to the measured value. In initial plating, the region where the foil was clamped failed to plate effectively due to imperfectly applied pressure in that area, resulting in a black patch. The solenoid was then re-mounted to more consistently apply pressure there followed by a final plating run without turning on the motor to plate this region. This is an imperfection in our current clamping setup rather than an issue with the technique, and with an improved clamp design the solenoid would plate evenly.

Various other embodiments provide selective plating of components or portions thereof by using multiple conductive segments/section that are electrically isolated, such that different segments/section can be plated at different times.

Thus, the various embodiments provide systems, apparatus, methods and mechanisms to electroplate selectively onto FFF printed parts to improve electrical properties and print true electromechanical systems.

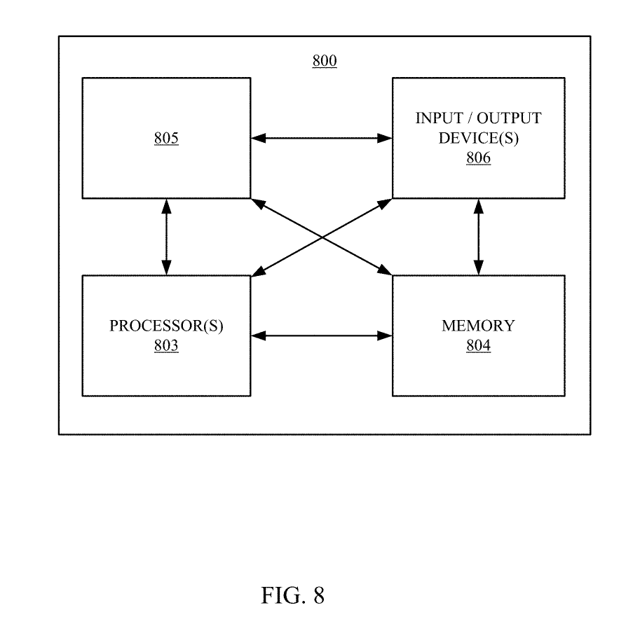

FIG. 8 depicts a high-level block diagram of a computing device, such as a processor or other functional element suitable for use within the system 100 of FIG. 1, as described above and with respect to the various other figures. In particular, any of the various functional entities described herein, such as controller 110, a.m. module 101, electroplating module 102 and so on within the now that embodiments be implemented in accordance with a general computing device structure such as described herein with respect to FIG. 8.

As depicted in FIG. 8, computing device 800 includes a processor element 803 (e.g., a central processing unit (CPU) or other suitable processor(s)), a memory 804 (e.g., random access memory (RAM), read only memory (ROM), and the like), a cooperating module/process 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware or in a combination of software and hardware, e.g., using a general purpose computer, one or more application specific integrated circuits (ASIC), or any other hardware equivalents. In one embodiment, the cooperating process 805 can be loaded into memory 804 and executed by processor 803 to implement the functions as discussed herein. Thus, cooperating process 805 (including associated data structures) can be stored on a computer readable storage medium, e.g., RAM memory, magnetic or optical drive or diskette, and the like.

It will be appreciated that computing device 800 depicted in FIG. 8 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method of fabricating a component, comprising:
using a dual material additive manufacturing process configured to selectively deposit onto a substrate a relatively non-conductive polymer material and a relatively conductive polymer material to form thereby a three dimensional (3D) structure having respective non-conductive sections and conductive sections, the conductive polymer material including conductive composite filaments; and
using an electroplating process configured to deposit a metallic layer onto at least one of the conductive sections of the 3D structure to form the component.

2. The method of claim 1, wherein the non-conductive and conductive polymer materials both comprise thermoplastic materials.

3. The method of claim 1, wherein the non-conductive and conductive polymer materials both comprise photopolymer materials.

4. The method of claim 1, wherein the electroplating process is configured to selectively electroplate a subset of the conductive sections.

5. The method of claim 1, wherein the electroplating process is repeated for each of a plurality of metal deposition steps, wherein each metal deposition step is configured to selectively electroplate a subset of the conductive sections.

6. The method of claim 1, wherein the at least one conductive sections are configured to accept deposition of a metallic layer via electroplating without further processing.

7. The method of claim 5, wherein each of the conductive sections are configured to accept deposition of a metallic layer via electroplating without further processing.

8. The method of claim 5, wherein each of the plurality of metal depositions steps is configured to deposit a different layer of metal.

9. The method of claim 1, wherein at least one conductive section comprises a non-line-of-site section formed within the interior of the 3D structure.

10. The method of claim 3, further comprising removing at least a portion of said 3D structure prior to at least one of said metal deposition steps.

11. The method of claim 10, wherein said portion of said structure is removed via immersion of said portion of said 3D structure in a solvent.

12. The method of claim 11, wherein said removed portion of said 3D structure comprises a polymer portion of a conductive section having a metallic layer deposited thereon, said metallic layer remaining after removal of said polymer portion.

13. The method of claim 9, wherein said 3D structure comprises a printed circuit board (PCB), and said on-line-of-site section formed within the interior of the 3D structure comprises a conductive trace formed within a PCB layer.

14. The method of claim 13, wherein said PCB comprises a plurality of layers, and said non-line-of-site section formed within the interior of the 3D structure comprises a conductive through-hole to electrically connect conductive traces within two or more PCB layers.

15. Apparatus for fabricating a component, comprising:
a dual material additive manufacturing module configured to selectively deposit onto a substrate a relatively non-conductive polymer material and a relatively conductive polymer material to form thereby a three dimensional (3D) structure having respective non-conductive sections and conductive sections, the conductive polymer material including conductive composite filaments; and
an electroplating module, configured to deposit a metallic layer onto at least one of the conductive sections of the 3D structure to form the component.

16. The apparatus of claim 15, wherein the polymer materials comprise one of thermoplastic materials and photopolymer materials.

17. The method of claim 1, wherein the electroplating process is configured to selectively electroplate a subset of the conductive sections.

18. The apparatus of claim 15, wherein the electroplating module is configured to deposit a respective metallic layer onto each of a plurality of conductive sections.

19. The apparatus of claim 15, wherein the at least one conductive sections are configured to accept deposition of a metallic layer via electroplating without further processing.

20. A system for fabricating a component, comprising:
a dual material additive manufacturing module configured to selectively deposit onto a substrate a relatively non-conductive polymer material and a relatively conductive polymer material to form thereby a three dimensional (3D) structure having respective non-conductive sections and conductive sections, the conductive polymer material including conductive composite filaments; and
an electroplating module, configured to deposit a metallic layer onto at least one of the conductive sections of the 3D structure to form the component.
